(19) United States
(12) Patent Application Publication
(10) Pub. No.: US 2009/0317172 A1
(43) Pub. Date: Dec. 24, 2009

(54) Writing Tip For Tracing Lines of Different Widths and Writing Implement Comprising Such a Tip

(75) Inventors: Vincent Bedhome, Dezvres (FR); Franck Rolion, Asnieres Sur Oise (FR)

Correspondence Address: JONES DAY, 222 EAST 41ST ST, NEW YORK, NY, 10017, US

(73) Assignee: SOCIÉTÉ BIC, Clichy (FR)

(21) Appl. No.: 12/296,387

(22) PCT Filed: Apr. 6, 2007
(86) PCT No.: PCT/FR2007/000592

§ 371 Date: Dec. 16, 2008

(30) Foreign Application Priority Data
Apr. 12, 2006 (FR) 06 03240

(51) Int. Cl. B43K 8/06

(52) U.S. Cl. 401/198

(57) ABSTRACT

A capillary writing tip that includes a body extending from a base along a central axis (Z) to a peak, the body having a main face with a maximum dimension (L) measured transversally with respect to the central axis and delimited by a main base edge adjacent to the base, as well as by a first and a second substantially straight peak edge, which meet at the peak and are of respective lengths (l) less than the maximum length. The body also has a first secondary face delimited by, among other things, the first peak edge; a second secondary face delimited by, among other things, the second peak edge; the first and second secondary faces presenting a substantially straight common edge extending from the peak to a lower end adjacent to the base, the common edge having a length (m) which is different from the maximum width (L) and from the length (l) of the first and second peak edges.

### CROSS-REFERENCE TO RELATED APPLICATIONS

This application is a national stage application of International Application No. PCT/FR2007/000592, filed on Apr. 6, 2007, which claims priority to French Patent Application No. 06 03240 filed on Apr. 12, 2006, the entire contents of both applications being incorporated herein by reference.

### FIELD OF INVENTION

The embodiments of the present invention relate to a writing tip suitable for tracing lines of different determined widths.

The embodiments of the present invention relate to a capillary writing tip comprising a body extending from a base along a central axis to a peak, the body having a main face with a maximum dimension measured transversally with respect to the central axis, called maximum width, and delimited by a main base edge adjacent to the base, as well as by a first and a second substantially straight peak edge, which meet at the peak and have respective lengths less than the maximum length.

### BACKGROUND OF THE EMBODIMENTS OF THE PRESENT INVENTION

Writing tips of this type, known for example from the document DE-A-33 36 664, are commonly used in writing implements of the felt pen, marker or highlighter type. The peak of the tip makes it possible to write or underline by tracing a fine line. The main face, and most often two opposite main faces, makes it possible, by positioning the latter against the plane of the sheet of paper, to trace a line of great width, for example to underline or highlight a text. The peak edge of greater length, which is often substantially equal to the maximum length of the main face as in the case of FIG. 2 of the document DE-A-33 36 664, also makes it possible to trace a line of great width by bringing this edge into contact against the sheet of paper while still allowing greater freedom of angular position of the implement.

It is possible to trace lines of intermediate width by positioning the peak edge at an angle to the direction of movement, but this requires a degree of dexterity which inevitably results in variations in width when tracing a curved line.

Various solutions have been proposed with a view to providing writing tips making it possible to write in many different widths, and in particular providing conical tips with a peak which is off center with respect to the central axis as described in the document U.S. Pat. No. 5,897,264. However, while such a tip makes it possible to vary the width of the line continuously between two extremes, it requires precise positioning to trace a line of given width. It therefore proves impractical to change quickly and easily from one line width to another.

### SUMMARY OF THE EMBODIMENTS OF THE PRESENT INVENTION

A need therefore exists for writing tips allowing to trace different lines of precise and determined width, and in particular allowing a fine line for writing, a line of average thickness for underlining and a wide thickness for highlighting.

An object of the embodiments of the present invention is therefore to provide a writing tip making it possible to trace lines in precise and determined different widths, namely at least three widths, while still offering easy and comfortable use.

To this end, an embodiment of the present invention is a writing tip of the above-mentioned type, characterized in that the body also has:
a first secondary face delimited by a first base edge adjacent to the base, and by the first peak edge;
a second secondary face delimited by a second base edge adjacent to the base, and by the second peak edge;
the first and second secondary faces presenting a substantially straight common edge extending from the peak to a lower end adjacent to the base, the common edge having a length which is different from the maximum width and from the length of the first and second peak edges.

The maximum width, the lengths of the peak edges and the length of the common edge make it possible to trace lines in three different widths, and even four different widths if the first and second peak edges are of different length. In fact, the common edge extending to the base creates an additional tracing zone of clearly defined length, in an analogous manner to the first and second peak edges. Compared with the tips of the prior art which generally comprise only two peak edges, or two pairs of peak edges, in the case of a peak which is not pointed, extending to the base, a third edge is obtained extending to the base thanks to the tip as defined above. The writing-width possibilities are therefore increased while still preserving very good writing comfort. These line widths are of course in addition to the fine line that can be obtained with the peak by positioning the writing tip substantially perpendicular to the sheet.

In preferred embodiments of the present invention, one or other of the following arrangements can be used:
the first and second peak edges preferably have the same length, thus the writing tip can be used as easily by right-handed as by left-handed individuals;
the first peak edge preferably has a length comprised between 40 and 80% of the maximum width, the common edge preferably has a length comprised between 30 and 60% of the maximum width and preferably at least 15% less than the length of the first peak edge; these relationships between the length allow clearly differentiated writing widths while still offering writing comfort for the user;
the main base edge is preferably substantially straight, and preferably of a length substantially equal to the maximum width, thus the line of maximum width can also be obtained using an edge, which allows a greater freedom of inclination of the writing implement;
the main face is preferably plane, which makes it possible to apply a large quantity of ink rapidly,
the base preferably has a cross-section with respect to the central axis which is globally rectangular, this arrangement allowing a great amplitude between the width of the different lines without excessively increasing the space required by the tip;
the peak of the writing tip is preferably offset with respect to the central axis, and preferably offset on the side of the common edge, this arrangement making it possible to increase the difference between the maximum width and the length of the common edge;
the first and second peak edges form between them an angle preferably in the plane of the main face which is comprised between 90 and 150 degrees, experience showing that good writing comfort is retained;
the common edge preferably forms with the central axis an angle comprised between 30 and 60 degrees, also for writing comfort;
edges preferably have a rounded profile;
the body and the base are preferably integrally formed by sintering a granular material comprising synthetic resin and preferably polypropylene.

### BRIEF DESCRIPTION OF THE EMBODIMENTS SHOWN IN THE DRAWINGS

The embodiments of the present invention also relate to a writing implement comprising a barrel containing ink and having at a front end an opening on which a tip as defined previously is mounted, the base of the tip preferably projecting from the barrel of the implement.

Other characteristics and advantages will become clear from the following description, given as a non-limitative example, with reference to the attached figures in which:

FIG. 1 is a partial perspective view of a writing implement comprising a writing tip according to a preferred embodiment of the invention;

FIG. 2 is an enlarged front view of a preferred embodiment of the writing tip;

FIG. 3 is a view from above the tip shown in FIG. 2;

FIG. 4 is a view from below the tip shown in FIG. 2;

FIG. 5 is a partial side view of the tip shown in FIG. 2.

### DETAILED DESCRIPTION OF THE EMBODIMENTS OF THE PRESENT INVENTION

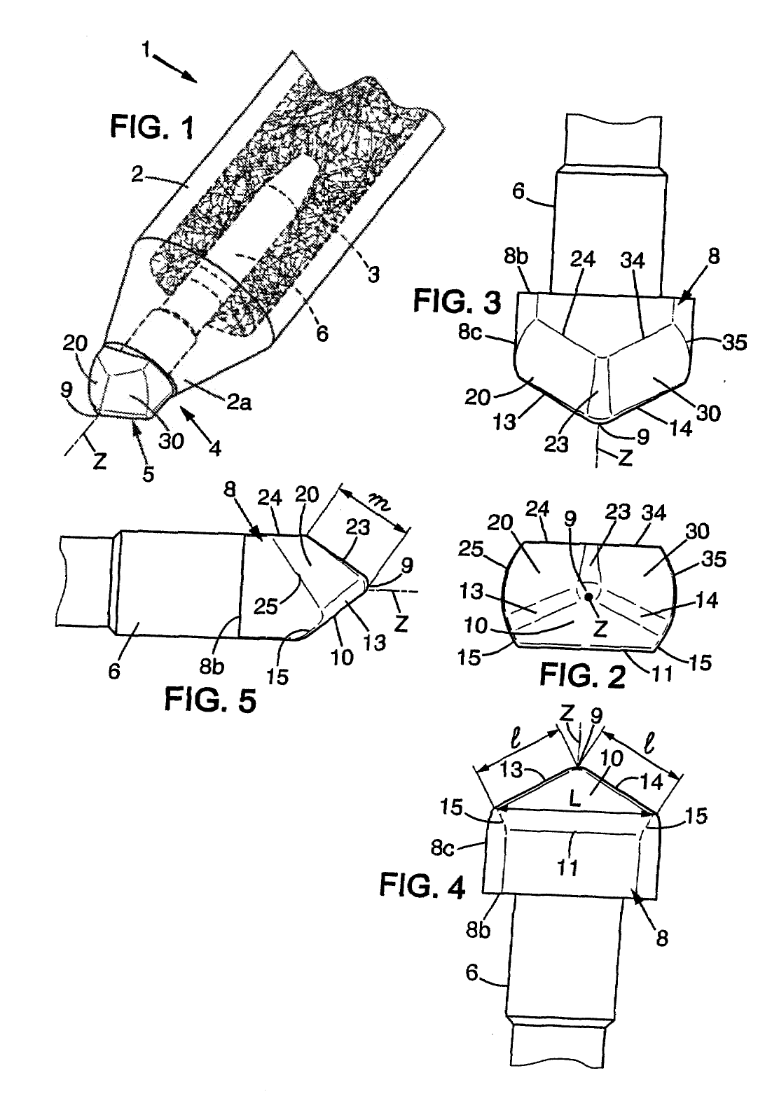

FIG. 1 shows a writing implement 1 comprising a barrel 2 inside which a reservoir of ink is arranged and having, at a front end 2a, an opening in which a writing tip 4 is mounted.

The ink reservoir 3, diagrammatically represented in broken lines, is a fibrous pad impregnated with ink in a well-known manner. But it could be any other type of ink reservoir, in particular a reservoir containing free ink.

The writing tip 4 preferably comprises a tip body 5 and a connector 6 immovably attached to the body 5 which in a known manner allows the mounting of the writing tip in the opening of the barrel 2 and the supply of the ink to the front end of the writing tip, i.e. to the body 5 of the latter. The body 5 and the connector 6 are made of capillary material making it possible to supply the ink in regular fashion, and formed in a single piece. It is however perfectly possible to provide a tip body and a connector in two elements or also to provide an additional intermediate connector, depending on the structure of the front end of the barrel and the nature of the liquid to be used.

As FIGS. 2 to 5 more clearly show, the body 5 of the tip comprises a base 8 from which a main face 10, a first secondary face 20 and a second secondary face 30 extend to a peak 9. The body 5 therefore extends overall along a central axis Z coaxial with the center of the base 8, and in the embodiment represented, coaxial with the longitudinal axis of the connector 6.

The base 8 is formed by a volume delimited by a plane front face 8b, an annular side wall 8c and a front face, not referenced, more or less complex in shape, which is defined by the connecting edges between the annular wall 8c and the main and secondary faces (10, 20, 30). It is however also conceivable that the base 8 is in the form of a more flattened volume, or even of a plane.

As can be seen better in FIG. 4, the main face 10 is delimited by a straight main base edge 11, by first and second peak edges (13, 14) which are also straight and meet at the peak 9. Complementary base edges 15 of reduced length make it possible to connect the ends of the main base edge 11 to the lower ends of the first and second peak edges (13, 14). These complementary base edges 15 are mainly due to the cross-section of the base 8 which is in the form of a rectangle with small sides in the form of an arc of a circle as can be seen clearly in FIG. 2. But it is perfectly possible to have the first and second peak edges (13, 14) extend to a straight main base edge.

The main face 10 thus defined is plane to allow a line to be traced by applying this entire face against a sheet of paper, which makes it possible to deposit a large quantity of ink.

The main face 10 has a maximum dimension L measured transversally with respect to the central axis Z which is called maximum width L. In the configuration represented, this maximum width L corresponds to the distance separating the lower end of the peak edges (13, 14). It will be noted that this distance L is only very slightly greater than the length of the main base edge 11 given the reduced length of the complementary base edges 15.

The peak edges (13, 14) have a length l which is identical in this preferred embodiment in order to allow easy drawing of a line in a given length corresponding to this edge length l.

The first secondary face 20 which can be better seen in FIG. 2 is delimited in part by the first peak edge 13 and a common edge 23 with the second secondary face 30. The common edge 23 extends from the peak 9 to the base 8, and is straight over a length m so as to allow a wide line to be traced with the latter. The first secondary face 20 is also delimited by a base edge 24, which is straight and inclined with respect to the transverse plane of the body 5, and a complementary base edge 25 in the form of an arc of a circle due to the end faces in the form of an arc of a circle of the annular wall 8c of the base. In this embodiment, the first secondary face 20 is not completely flat, as a result it is not expressly provided to trace lines by contact of the whole of this face.

In analogous manner, the second secondary face 30 is delimited by the second peak edge 14, the common edge 23 and main 34 and complementary 35 base edges. The second secondary face is therefore symmetrical to the first secondary face 20 with respect to a plane passing through the central axis Z and comprising the common edge 23. However, it is quite possible that the second secondary face 30 is substantially different from the first secondary face 20, for example in order to provide a second peak edge 14 of different length from the first.

The first and second peak edges (13, 14) and the common edge 23 meet at a single point which forms the peak 9 of the writing tip 4. Thus, this peak has a pointed surface, arranged close to the central axis, and is therefore particularly well suited to tracing fine and precise lines. It will be understood that the rounded pointed surface of the peak allows the drawing of a fine line of constant width, i.e. without downstrokes and upstrokes, by holding the writing implement almost vertical regardless of the angular orientation of the tip about its central axis with respect to the direction of writing.

Thus configured, the body 5 provides, in addition to the peak 9, different faces and edges making it possible to trace a line of determined widths. Namely, a width chosen from the maximum width L and/or the main base edge 11 of the main face 10, the first and second peak edges (13, 14) of the same length l, or the common edge 23 which has the length m visible in FIG. 5. In order to allow lines to be drawn in three different widths, the maximum width L, the length l of the first and second peak edges (13, 14), and the length m of the common edge 23 are different, the last two lengths preferably being less than the maximum width L.

In order that the possible different lines drawn have visibly different widths, the length l of the peak edges is comprised between 40 and 80% of the maximum length L and preferably close to 50% of this length L. The common edge 23 has a length m comprised between 30 and 60% of the maximum width and preferably slightly greater than 40% of the latter. On the other hand, for the width of the lines traced by the peak edges and the common edge 23 to be clearly visible, it is sufficient for the length m of the common edge to be at least 15% less than the length l of the peak edges (13, 14). But, of course, these proportions can be substantially different depending on the sought result, for example by modifying the geometry of the base 8 and the angles of inclination of the faces or edges.

On the other hand, it is also possible to multiply the predetermined writing widths offered by the writing tip produced according to an embodiment of the present invention. For example, it is perfectly possible to adopt a different length between the first and second peak edges (13, 14), or to provide for a width L substantially different from the length of the main base edge 11 and thus obtain two different writing widths by applying either the main face 10 against the sheet, or only the main base edge 11 of the latter. Finally, it can also be envisaged that the other base edges deliver identical or different writing widths.

However, it must be ensured that each edge or face designed for writing has a clearance with respect to the remainder of the writing tip 4 and the barrel 2 of the implement in order that writing is possible, and that the angle of inclination of the writing implement, i.e. of the central axis Z, with respect to the paper or any other medium, remains acceptable for the user. To this end, the angle of inclination of the common edge 23 with respect to the central axis Z is comprised between 30 and 60 degrees. The angle formed by the main face 10 with the central axis Z is also included in this range. The angle formed between the first peak edge 13 and the second peak edge 14 is preferably comprised between 90 and 150 degrees. For writing comfort of left-handed and right-handed individuals, it is also desirable that the angle formed by each of the peak edges (13, 14) with the central axis Z is identical, and therefore comprised between 45 and 75 degrees. All of the angle values indicated correspond to angles measured on the side of the body 5 of the writing tip.

Other arrangements are provided in order to be able to clearly differentiate between the lengths of the different edges and the maximum width L. It may be noted for example that the peak 9 is slightly offset on the side of the common edge 23 with respect to the central axis Z, with the aim of increasing the surface of the main face 10 and reducing the length m of the common edge 23. On the other hand, a base 8 of overall rectangular cross-section is adopted and the main face 10 is worked such that the main base edge 11 corresponds to one of the long sides of this rectangular section in order to obtain the greatest possible maximum width L, but also in order to obtain peak edges (13, 14) of significant length relative to the dimensions of the body 5.

It will be noted that the edges intended to trace a line, namely the main base edge 11, the peak edges (13, 14) and the common edge 23, have a rounded profile. This allows a tangent contact with the sheet of paper over a significant surface area, makes the tip less sensitive to wear and allows a not insignificant variation in the angle of inclination of the writing implement about the axis formed by this edge.

The body of the writing tip is produced by sintering of a granular material in a mould. Thus, it is possible to produce a complex and very precise shape, even with items produced on a very large scale. The granular material is advantageously a synthetic resin and in particular a resin composed mainly of polypropylene, with which the hot sintering operation is easy.

In order to trace lines of different widths, it is sufficient for the user to point the writing tip 4 at an angle about its central axis Z in the direction of the line that he wishes to trace, i.e. essentially relative to his hand, and to incline the writing implement 1 relative to the sheet of paper so as to bring into contact the edge or the face that they wish to use. This inclination is maintained during the tracing of the line due to the pressure exerted on the tip by the user. Tests show that the use of a tip such as that of the embodiment represented which allows four writing widths in total is intuitive for the user. Moreover, this use is relatively easy due to the angular displacement allowed by this tip with respect to a nominal inclination.

1.-13. (canceled)

14. A capillary writing tip comprising a body extending from a base along a central axis to a peak, the body having a main face with a maximum dimension measured transversally with respect to the central axis, called maximum width, and delimited by a main base edge adjacent to the base, as well as by a first and a second substantially straight peak edge, which meet at the peak and are of respective lengths less than the maximum width,
wherein the body further comprises a first secondary face delimited by the first peak edge, a second secondary face delimited by the second peak edge, and
wherein the first and the second secondary faces present a substantially straight common edge extending from the peak to a lower end adjacent to the base, the common edge having a length which is different from the maximum width and from the respective lengths of the first and second peak edges.

15. The writing tip according to claim 14, wherein the first and the second peak edges have the same length.

16. The writing tip according to claim 14, wherein the first peak edge has a length between 40 and 80% of the maximum width, the common edge has a length between 30 and 60% of the maximum width and at least 15% less than the length of the first peak edge.

17. The writing tip according to claim 14, wherein the main base edge is substantially straight, and substantially equal in length to the maximum width.

18. The writing tip according to claim 14, wherein the main face is plane.

19. The writing tip according to claim 14, wherein the base has a cross-section with respect to the central axis which is rectangular overall.

20. The writing tip claim 14, wherein the peak of the writing tip is offset with respect to the central axis, and offset on the side of the common edge.

21. The writing tip according to claim 14, wherein the first and the second peak edges form between them an angle in the plane of the main face which is between 90 and 150 degrees.

22. The writing tip according to claim 14, wherein the common edge forms with the central axis an angle between 30 and 60 degrees.

23. The writing tip according to claim 14, wherein the edges have a rounded profile.

24. The writing tip according to claim 14, wherein the body and the base are integrally formed by sintering a granular material comprising synthetic resin and polypropylene.

25. A writing implement comprising a barrel containing ink and having a front end provided with an opening on which a writing tip is mounted, the writing tip being a capillary writing tip comprising a body extending from a base along a central axis to a peak, the body having a main face with a maximum dimension measured transversally with respect to the central axis, called maximum width, and delimited by a main base edge adjacent to the base, as well as by a first and a second substantially straight peak edge, which meet at the peak and are of respective lengths less than the maximum width,
wherein the body further comprises a first secondary face delimited by the first peak edge, a second secondary face delimited by the second peak edge, and
wherein the first and the second secondary faces present a substantially straight common edge extending from the peak to a lower end adjacent to the base, the common edge having a length which is different from the maximum width and from the respective lengths of the first and second peak edges.

26. The writing implement according to claim 25, wherein the base of the tip projects from the barrel of the implement.
